(19) United States
(12) Patent Application Publication
(10) Pub. No.: US 2013/0216461 A1
(43) Pub. Date: Aug. 22, 2013

(54) NITRIC ACID PRODUCTION

(71) Applicant: Naresh J. Suchak, Glen Rock, NJ (US)

(72) Inventor: Naresh J. Suchak, Glen Rock, NJ (US)

(21) Appl. No.: 13/590,424

(22) Filed: Aug. 21, 2012

Related U.S. Application Data
(60) Provisional application No. 61/525,899, filed on Aug. 22, 2011.

(51) Int. Cl. C01B 21/40

(52) U.S. Cl. CPC C01B 21/40
USPC 423/235; 423/394.2; 423/392; 423/210

(57) ABSTRACT

A method for reducing the levels of nitrogen oxides in the tail gas from a nitric acid production process by adding ozone to the absorber column of the production process. Nitric acid formation is also intensified by adding a mixture of secondary air and oxygen to the absorber column.

### CROSS REFERENCE TO RELATED APPLICATIONS

This application claims priority from U.S. provisional application Ser. No. 61/525,899 filed Aug. 22, 2011.

### BACKGROUND OF THE INVENTION

The invention provides for lower of nitrogen oxides emissions from tail gas streams in nitric acid production process whereby nitric acid manufacturing is improved.

Nitric acid is generally manufactured by the high temperature oxidation of ammonia over noble metal catalyst with air. Ammonia oxidation mainly results in the formation of NO as the process gas stream is cooled in the heat recovery equipment. During cooling, substantial amounts of NO oxidizes to form NO₂ in the presence of oxygen in the process gas stream while some water vapor also condenses. This NO and NO₂ containing gas stream is contacted with an aqueous medium in a counter current fashion in multiple stages of absorption equipment to form an aqueous solution of nitric acid. Many reactions occur in the gas and liquid phase as well as during cooling, condensing and absorption in the equipment involved. Nitric acid absorption is a most complex industrially practiced absorption system. As process gas flows through multiples stages of gas-liquid contact, NO_{X} concentration depletes gradually. In the final stages, NO_{X} concentrations in the process gas stream are very low, typically less than 0.5% by volume and the scrubbing medium is process water (aqueous feed stream).

Temperature, pressure, and gas-liquid velocities are some of the important parameters which impact on the absorption and process in general thereby affecting the strength of nitric acid solution produced and the final concentration of NO_{X} in the tail gas that can be attained. The tail gas from absorption process, in plants operated at pressures higher than ambient are heated and energy from pressurized gas stream is recovered in the turbo expander prior to exhausting to the atmosphere.

Generally plants operating at higher absorption pressure tend to have lower emissions. With increasing environmental concerns and stricter regulations, recently constructed plants tend to be rated for operations at higher pressures of 13 Bar gauge, while older plants, especially those built several decades ago were designed for operation at near ambient pressure. In industrially developed nations, most of the nitric acid production plants that operate at ambient pressure have been curtailed due to inherently higher NO_{X} emissions.

Generally limits on allowable NO_{X} emissions in the tail gas are defined in pounds of NO_{X} emissions per ton of acid produced. Although some older plants with lower pressure tend to have higher NO_{X} emissions, they are often not required to meet more recent and stricter standards as required for newly install plants.

There are a number of technologies and industrial practices for lowering NO_{X} emissions from tail gas. Amongst the more widely suggested are Selective Catalytic Reduction (SCR), Selective Non-Catalytic Reduction (SNCR), Non-Selective Non-Catalytic Reduction, scrubbing with alkaline solution to form nitrate/nitrite and extending aqueous scrubbing at low temperature around 4° C. in the absorption column. The selection and practice of NO_{X} emissions control method will vary from case to case depending on operating parameters of the nitric acid production process, regulatory mandates and economic attractiveness.

In recent years, modern nitric acid production plants operating at high pressure have lower temperature extended absorption section in the absorption equipment to lower nitrogen oxides emissions. The temperature of the absorption process is lowered in the tail gas section of the equipment. In this extended absorption section, the tail gas is held for a longer period of time at lower temperature compared to the rest of the absorption equipment and have achieved far lower emissions than those historically practiced. This approach is not effective at lowering emissions sufficiently with medium and lower pressure processes.

Therefore, low pressure and medium pressure processes tend to choose technologies based on reduction processes to achieve lower emissions. These reduction based technologies (SCR, SNCR, etc.) require adding equipment downstream of the absorption process. The reduction processes require higher operating temperatures and therefore the tail gas stream must be heated upstream of the reduction process equipment. Nitric acid manufacturing is tightly heat integrated, i.e., the streams that need cooling provides heating to the streams that need heating and excess heat is used in generating steam that could be exported.

It is easier to accommodate and incorporate reduction processes within the heat envelope of nitric acid manufacturing for a new plant but it becomes costly when retrofitting an existing installation already used in production. The various challenges include re-engineering heat recovery and reconfiguring process design, accommodating additional equipment in the existing layouts, establishing new process parameters for operations, loss of production during retrofits, startup and handling of process disturbances. During normal operations and especially during startup and disturbances monitoring secondary emissions of reducing agent in the stack is an additional commitment for the life of the plant's operation. The cost burden of retrofitting nitrogen oxides reduction process is even more pronounced for lower pressure, smaller capacity plants.

In order to reach very low NOx emissions, ozone based NOx oxidation of exhaust is one of the viable approach. U.S. Pat. No. 5,206,002 teaches that for nitrogen oxides to be effectively removed, ozone is injected into the exhaust gas stream and allowed to mix and react by providing a residence time large enough to convert substantial parts of NO to N₂O₅ and then absorbing in an aqueous medium. The process described in this patent can be applied to the exhaust stream leaving the turbo expander prior to exhausting to the atmosphere. However, that requires separate process equipments at substantial capital investment and will result in scrubber purge stream and wet stack.

Nitric acid is one of the basic low priced chemical commodities used in process industry with a major share of its consumption in making fertilizers. The demand for fertilizers is cyclical and for smaller capacity plants, it is sometimes economically attractive to increase the production of nitric acid by enriching secondary air with oxygen. In some industrially developed countries, increasing nitric acid production capacity, even by oxygen enrichment, triggers environmental re-permitting process which may require implementing state of the art nitrogen oxides reduction technology or at a minimum keeping the total nitrogen oxides emissions within the permitted quota.

The approach in the present invention is to integrate ozone based oxidation within nitric acid absorption system which not only provides flexibility in lowering nitrogen oxides emissions without making significant changes in the process or modifications to the equipment but also allows the nitric acid producer to focus on maximizing production with or without oxygen enrichment. In contrast all reduction based nitrogen oxides control technologies require alterations in the heat envelope or heat input and major process modification that will affect nitric acid production.

### SUMMARY OF THE INVENTION

Accordingly, there is disclosed a method for removing contaminants from a tail gas stream of a nitric acid production process wherein nitric acid is recovered from an absorber column comprising adding ozone to the absorber column.

In another embodiment, there is disclosed a method for removing contaminants from a tail gas stream of a nitric acid production process wherein nitric acid is recovered from an absorber column comprising feeding a process gas stream and an enhanced oxygen-containing stream into an absorber column and adding ozone to the absorber column.

In a further embodiment, there is disclosed a method for producing nitric acid comprising the steps of:

a) reacting ammonia in an ammonia converter;
b) feeding reaction products from step a) to a waste heat recovery unit;
c) feeding the reaction products from step b) to a heat exchanger thereby heating the reaction products;
d) feeding the reaction products of step c) to a cooler condenser thereby cooling the reaction products;
e) feeding the cooled reaction products of step d) to an absorber column wherein nitric acid is separated from a tail gas; and
f) feeding ozone to the absorber column to react with contaminants in the tail gas.

The contaminants that are treated by the methods of the present invention are typically nitrogen oxides. The absorber column is typically a multistage absorber column that may also be a plate column having between about 20 to about 70 plates. The ozone will contact the nitrogen oxides in between the plates. The ozone may be added to the final stages of the absorber column after being raised in pressure to be approximately the same as the pressure of the absorber column. Oxygen enrichment may also occur by introducing oxygen into the absorber column.

Accordingly, the invention addresses these concerns by lowering nitrogen oxides emissions from tail gas streams in nitric acid production processes while intensifying the production of nitric acid.

The invention offers advantages to the nitric acid production facility. No significant modifications need to be made to the nitric acid production process itself, or to the equipment used in nitric acid production. No modifications are necessary to heat recovery schemes or related equipment. The nitrogen oxides emissions are not only inhibited but are converted to incrementally increase the production of nitric acid. Any installations are relatively simple and controlled.

The nitrogen oxides emissions are lower than by other known techniques. These nitrogen oxides emissions can be lowered in the tail gas incrementally as required by regulation by increasing the quantity of ozone added. Lastly there are no secondary emissions through the inventive use of ozone.

Nitrogen oxides concentrations in the tail gas leaving the absorption equipment are lowered by adding ozone in the final absorption stages where the tail gas is exhausted from the nitric acid absorption equipment. As such, very few additional processing equipment and minimal modifications of absorption equipment enables reduction of nitrogen oxides concentrations in the tail gas to lower than current environmental regulations.

Nitrogen oxides in the final stages of the absorption equipment are oxidized by ozone to form N₂O₅. Oxidation of nitrogen oxides with ozone is several orders of magnitude faster than with oxygen. The spaces between plates or final stages provide adequate space for the desired conversion of NO to N₂O₅. The solubility of N₂O₅ is high and results in complete dissolution in aqueous medium in the final stages. Absorption or dissolution of N₂O₅ forms nitric acid. In the absence of nitrous acid formation there is no decomposition reaction occurring in the final stages and therefore, no desorption of NO. Nitrogen oxides absorbed are retained in the final stages as stable nitric acid.

### BRIEF DESCRIPTION OF THE DRAWINGS

FIG. 1 is a schematic of a typical nitric acid production process.

FIG. 2 is a schematic of a nitric acid production process integrated with an ozone oxidation system.

FIG. 3 is a schematic of a nitric acid production process integrated with ozone oxidation and oxygen enrichment.

FIG. 4 is a schematic depicting the oxidation, absorption and desorption all occurring in a given stage.

FIG. 5 is a schematic depicting the oxidation and absorption in final stages (tail gas section).

### DETAILED DESCRIPTION OF THE INVENTION

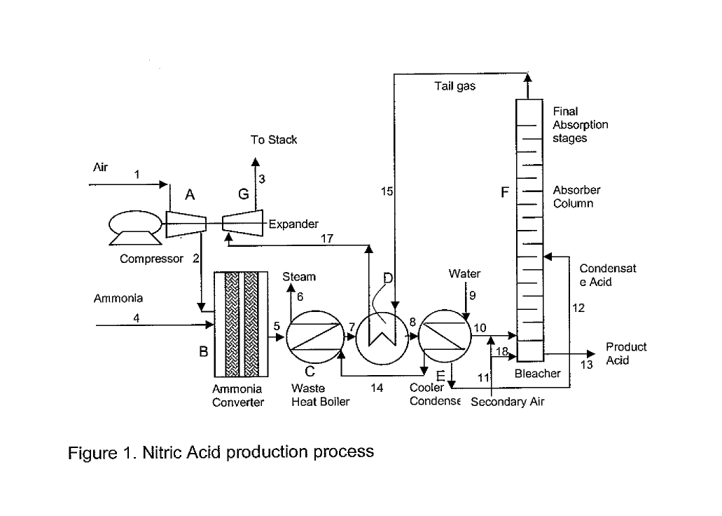

Turning to FIG. 1, there is disclosed a schematic of a nitric acid production process. Air is fed through line 1 to compressor A which feeds the compressed air through line 2 into ammonia converter B. Ammonia is fed through line 4 to premix with air and the ammonia is subjected to oxidation at high temperature on a noble metal catalyst surface present in ammonia converter B. The oxidation reaction is highly exothermic and converts ammonia into nitrogen oxides. The process gas stream leaving the ammonia converter B through line 5 essentially consists of nitrogen with the remainder oxygen, water in vapor form and oxides of nitrogen, particularly NO. The heat from the process gas stream leaving the ammonia converter is recovered in waste heat recovery unit C to form a high pressure steam in line 6 and to heat the tail gas in heat exchanger D and further removed in the cooler condenser E. Here, the high temperature heat recovered as steam in line 6 may be exported to generate power or utilized elsewhere within the process.

The process gas fed through line 7 through heat exchanger D then passes through line 8 which is further cooled in the cooler/condenser E where some of the water vapor present in the process gas stream condenses due to water feed to E through line 9. In the heat recovery and cooling section D and E nitrogen oxides in the process gas which is predominantly in the divalent form (mainly NO) oxidizes to tetravalent form (NO₂). The formation of NO₂ triggers formation of various other oxides such as N₂O₄, N₂O₃ and oxyacids (HNO₂ and HNO₃) in the process gas stream. Water and oxyacids condense in the cooler condenser E and some nitrogen oxides dissolve in the condensate forming oxy acids. The condensate stream consisting of weak nitric and nitrous acid is collected and fed through line 12 to the appropriate stage in the absorption equipment column F.

In a low, medium or high pressure nitric acid production process, the process gas leaving the cooler is introduced through line 10 in multistage absorption equipment such as a plate column whereas atmospheric pressure process has multiple packed columns placed in series as absorption system.

A typical plate column has an excess of 20 and as many as 70 plates as gas-liquid contacting stages. Air is supplementally added through line 11 to line 10 to the cooled process gas stream to provide additional oxygen required for oxidizing NO (divalent nitrogen oxide) to NO₂ (tetravalent nitrogen oxide). Part of the supplementary air 18 is also bubbled through a bleacher section at the bottom section of the absorber column F that holds product acid. The process gas stream is introduced into the absorber column F at the bottom and rises upward progressively through contacting stages while aqueous stream of process water is introduced at the top of the column to flow downward. Nitric acid is formed in the aqueous phase due to absorption of NO_{X}. The spaces between plates provide oxidation reaction time for gas phase oxidation of NO to NO₂ whereas the gas-liquid contacting stage (plate) provides necessary surface area for gases to absorb into the aqueous phase.

The product nitric acid is recovered from the absorber column F through line 13 where it is directed to equipment for further processing or to storage. The process gas stream entering absorber column F through line 10 undergoes absorption and oxidation reactions noted below and results finally in the tail gas stream. The tail gas exits the absorber column F through the top through line 15 to the heat exchanger D. The tail gas stream is indirectly heated by exchanging heat with the process gas stream entering through line 7. The heated tail gas stream 17 is fed to turbo expander G where pressure energy from the gas stream is recovered and then the gas stream 3 is vented through stack.

A number of reactions occur both in the gas as well as the liquid phase. Please refer to publications by Suchak et al (1991, 1994). For sake of brevity, we have simplified the oxidation and absorption reactions as follows

Cooling of NO in presence of oxygen results in oxidation of NO in the gas phase

6NO+3O₂→6NO₂ (1)

NO₂ dimerizes to form N₂O₄

6NO₂→3N₂O₄ (2)

When this gas is contacted with the aqueous liquid medium, the absorption of N₂O₄ and reaction with water forms HNO₃ and HNO₂ in the aqueous liquid phase

3N₂O₄+3H₂O→3HNO₃+3HNO₂ (3)

HNO₂ being unstable in the aqueous liquid phase, decomposes into NO and Nitric acid. NO having very poor solubility is released back to the gas phase.

3HNO₂→HNO₃+2NO+H₂O (4)

Therefore adding reactions 1-4 we get

6NO+3O₂+3H₂O→4HNO₃+2NO+H₂O (5)

As per reaction 5, oxidation and absorption of each mole of NO regenerates one third mole of NO again and released back in the gas phase.

Therefore when gas and liquid are contacted in a countercurrent fashion, the gas stream leaving carries NO released from the liquid due to decomposition reaction. Therefore in the multiple stage absorption equipment such as plate column, oxidation of NO occurs in the gas phase between two stages and decomposition of HNO₂ occurs in the liquid phase. Both absorption of N₂O₄ as well as desorption of NO occurs simultaneously when gas comes in liquid contact on the plate.

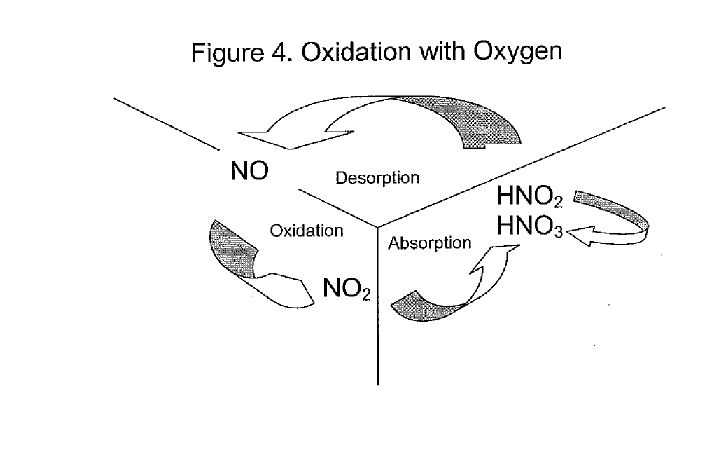

FIG. 4 represents the oxidation, absorption and desorption all occurring in a given stage.

Some of the contacting stages (plates) have cooling capability to remove excessive heat released during absorption and to further promote oxidation of NO in the gas phase between the plates.

As the process gas stream approaches the final stages of the absorption column, the concentration of NO_{X} is significantly depleted and oxidation of low concentrations of NO by oxygen present in the process gas is not fast enough to effectively convert divalent nitrogen oxides to tetravalent form in the space between the plates in the column. NO₂ deimerization to N₂O₄ is also limited at low concentration to effectively absorb in the aqueous phase.

It is also known from kinetic data that oxidation of NO can be enhanced by lowering the temperature of the gas phase. Therefore, NO oxidation can be improved by lowering temperature of the absorption stage as it reaches low concentration and also by increasing the partial pressure of oxygen.

The concentration of oxygen in the process gas is dictated by the total absorption pressure and stoichiometric excess air. For medium, low and ambient pressure absorption processes, oxygen concentration or partial pressure in the final stage is low and oxidation is slow. By increasing excess air, oxygen concentration increases but also results in an increase in total gas flow which reduces residence time available for NO oxidation to occur between two plates. On the other hand, oxygen concentration can be elevated by oxygen enrichment by replacing some of the secondary air with gaseous oxygen. Lowering nitrogen oxides in the tail gas by elevating oxygen concentration is an expensive proposition due simply to the costs of producing the oxygen unless accompanied by production intensification.

In high pressure processes, the partial pressure of oxygen is far greater than medium or low pressure processes and lowering the temperature to 4° C. in the final absorption stages can extend absorption and further lower levels of nitrogen oxides in the tail gas.

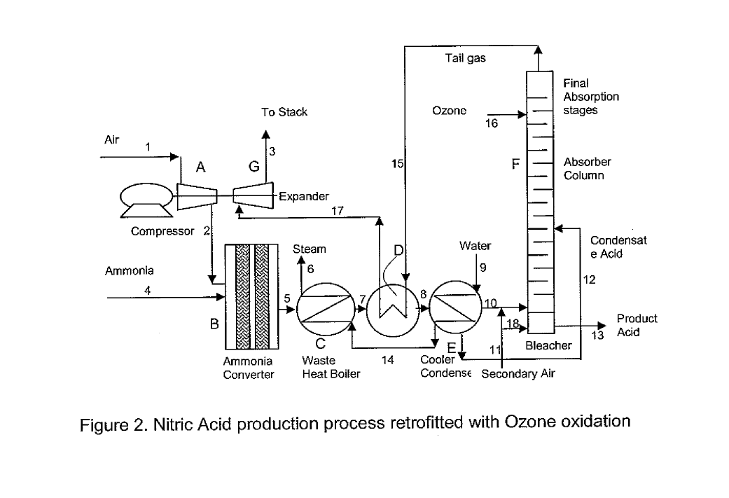

FIG. 2 represents a nitric acid production process retrofitted with ozone oxidation. The numbering convention from FIG. 1 is used up to the point of the ozone addition. Air is fed through line 1 to compressor A which feeds the compressed air through line 2 into ammonia converter B. Ammonia is fed through line 4 to premix with air and the ammonia is subjected to oxidation at high temperature on a noble metal catalyst surface present in ammonia converter B. The oxidation reaction is highly exothermic and converts ammonia into nitrogen oxides. The process gas stream leaving the ammonia converter B through line 5 essentially consists of nitrogen with the remainder oxygen, water in vapor form and oxides of nitrogen, particularly NO. The heat from the process gas stream leaving the ammonia converter is recovered in waste heat recovery unit C to form a high pressure steam in line 6 and to heat the tail gas in heat exchanger D and to heat boiler feed water in the cooler condenser E. Here, the high temperature heat recovered as steam in line 6 may be exported to generate power or utilized elsewhere within the process.

The process gas fed through line 7 through heat exchanger D then passes through line 8 to the cooler/condenser E where some of the water vapor present in the process gas stream condenses due to cooling water feed to E through line 9. In the heat recovery and cooling section D and E nitrogen oxides in the process gas stream which are predominantly in the divalent form (mainly NO) oxidizes to tetravalent form (NO₂). The formation of NO₂ triggers formation of various other oxides such as N₂O₄, N₂O₃ and oxyacids (HNO₂ and HNO₃) in the process gas stream. Water and oxyacids condense in the cooler condenser E and some nitrogen oxides dissolve in the condensate forming oxy acids. The condensate stream consisting of weak nitric and nitrous acid is collected and fed through line 12 to the appropriate stage in the absorption equipment column F.

In a low, medium or high pressure nitric acid production process, the process gas leaving the cooler is introduced through line 10 in multistage absorption equipment such as a plate column whereas atmospheric pressure process has multiple packed columns placed in series as absorption system.

A typical plate column has an excess of 20 and as many as 70 plates as gas-liquid contacting stages. Supplemental air is added through line 11 to line 10 to the cooled process gas stream to provide additional oxygen required for oxidizing NO (divalent nitrogen oxide) to NO₂ (tetravalent nitrogen oxide). Part of the supplementary air is also bubbled through a bleacher section at the bottom section of the absorber column F that holds product acid. The process gas stream is introduced into the absorber column F at the bottom and rises upward progressively through contacting stages while aqueous stream of process water is introduced at the top of the column to flow downward. Nitric acid is formed in the aqueous phase due to absorption of NO_{R}. The spaces between plates provide oxidation reaction time for gas phase oxidation of NO to NO₂ whereas the gas-liquid contacting stage (plate) provides necessary surface area for gases to absorb into the aqueous phase.

The product nitric acid is recovered from the absorber column F through line 13 where it is directed to equipment for further processing or to storage. The process gas stream entering absorber column F through line 10 undergoes absorption and oxidation reactions 1 to 5 summarized above until final absorption stages where ozone will be introduced through line 16. The tail gas exits the absorber column F through the top through line 15 to the heat exchanger D. The tail gas stream is indirectly heated by exchanging heat with the process gas stream entering through line 7. The heated tail gas stream 17 is fed to turbo expander G where pressure energy from the gas stream is recovered and then the gas stream 3 is vented through stack.

Ozone is generated from oxygen in a typical ozone generation unit (not shown) and if necessary, the pressure of the ozone containing oxygen is raised by compressor to the pressure of the absorption equipment. Ozone containing gas stream is introduced in the final absorption stages of the absorption column F through line 16.

The oxidation of NO with ozone is several orders of magnitude faster than that when oxygen is employed alone. The space between two plates in the final stages of the absorption equipment provides the required residence time for the oxidation of the nitrogen oxides to N₂O₅ (pentavalent form). Since pentavalent forms are highly soluble, they dissolve almost instantly in water. The pentavalent form selectively forms nitric acid in the aqueous medium. Since absorption of nitrogen oxides is through the pentavalent form, HNO₂ formation in the liquid phase by absorption of tetravalent form of NOx and decomposition to evolve NO is completely inhibited in the final stages of absorption making the absorption extremely effective in lowering nitrogen oxides leaving the tail gas section. In the case where ozone is introduced below the second plate from the top, the ozone oxidation process will occur in spaces between the second and third plate and first and second plate whereas absorption of nitrogen oxides as pentavalent oxides will occur on the second and first plate. Unlike the techniques taught in U.S. Pat. No. 5,206,002, all oxidation of nitrogen oxides need not occur in the gas phase at once but occur into multiple gas spaces between the absorption stages.

This solution further does not require any modification to the HNO₃ acid absorption equipment except for introducing ozone by line 16 into the vapor space. Ozone can also be introduced in the aqueous medium by either submerging line 16 in the liquid pool over the plate (not shown) or removing liquid from the plate in pump around loop (not shown) so the operator has a choice of means to input ozone into the final stages of the absorption column.

This solution is desirable for smaller capacity low, medium and atmospheric pressure nitric acid production facilities as production can be enhanced while tail gas nitrogen oxides emissions are maintained within environmental limits.

Nitrogen oxides oxidation with ozone follows several reaction paths to arrive at N₂O₅

2NO+2O₃→2NO₂+2O₂ (6)

NO₂+O₃→NO₃+O₂ (7)

NO₂+NO₃→N₂O₅ (8)

The absorption of N₂O₅ in the aqueous phase will result in the formation of nitric acid:

N₂O₅+H₂O→2HNO₃ (9)

Summing up equations (5) through (9)

2NO+3O₃+H₂O→2HNO₃+3O₂ (10)

Lowering the nitrogen oxides level from the tail gas will result in an incremental increase of the quantity of acid in the aqueous stream.

As stated elsewhere, in contrast to oxidation with O₂, the oxidation with ozone does not form HNO₂ in the aqueous phase and therefore no NO desorption occurs.

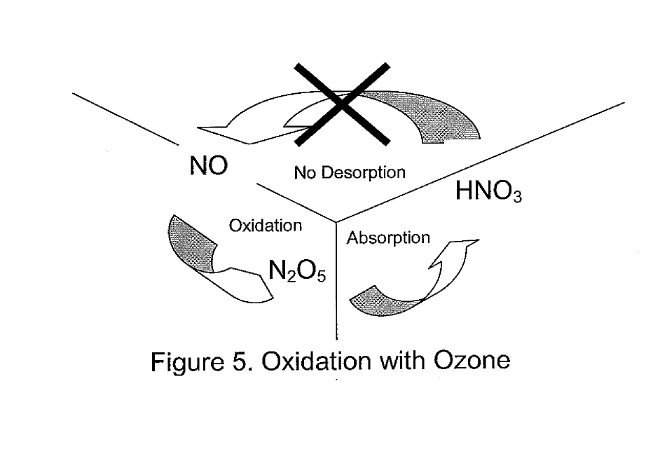

FIG. 5 represents the oxidation and absorption in final stages (tail gas section).

Secondary emissions are also inhibited as excess ozone is absorbed in the aqueous phase or destroyed when tail gas is heated prior to entering the expander G.

In a different embodiment of the invention, enhanced nitric acid production is possible while continuing to inhibit nitrogen oxides emissions. This is achieved by replacing a portion or up to all of the secondary air with oxygen. Typically, oxygen enrichment provides the required oxygen for the bulk of the conversion of NO to HNO₃; however, higher nitrogen oxides emissions in the tail gas results. Combining ozone feed in the tail gas section of the absorption unit with oxygen enrichment in the secondary air feed provides an intensified production of nitric acid without increasing nitrogen oxides emissions.

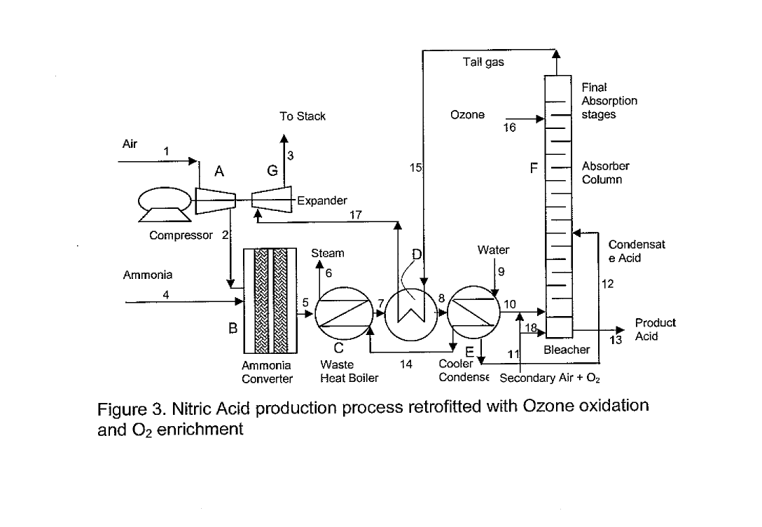

As noted in FIG. 3, the secondary air line 11 is replaced with a secondary air line and oxygen feed attachment which allows for feed of a combination of secondary air and oxygen with options to feed up to 100 percent oxygen content. The remainder of the numbering is the same as used in FIG. 1.

In another embodiment of the invention, lowering of NO_{X} emissions in the tail gas is possible in the near ambient pressure nitric acid process where the process gas is scrubbed in series of packed columns. While gas stream flows through series of packed column, it is contacted with aqueous nitric acid solutions progressively of weaker strengths. Product acid is withdrawn from the sump of first packed column and the aqueous weaker nitric acid from the 2^{nd} packed column replenishes the displaced volume in the sump of the first column. The sump in the 2^{nd} column is replenished by the aqueous nitric acid stream in the sump of 3^{rd} column. The sump of the final packed column is replenished with process water feed. Ozone is added in the final packed column to remove NOx as described in equations (6) to (10). The gas stream leaving the final packed column is directed to the stack since there in atmospheric pressure column there is no pressure energy to be recovered. Oxygen enrichment may be done by feeding oxygen to the secondary air supplied to the first packed column.

In another embodiment of the invention, NOx containing stream is arising from industrial process other than nitric acid manufacture such as nitric acid oxidation of organic material or processing of substances with nitric acid or processing materials where NOx is formed in the process. NO_{X} emissions from such a process stream can be lowered with effective recovery of nitric acid using gaseous oxygen to oxidize in series of packed columns. Gas stream is admixed with stoichiometric excess amount of oxygen. While gas stream flows through series of packed column, it is contacted with aqueous nitric acid solutions progressively of weaker strengths. The recovered nitric acid is withdrawn from the sump of first packed column and the aqueous weaker nitric acid from the 2^{nd} packed column replenishes the displaced volume in the sump of the first column. The sump in the 2^{nd} column is replenished by the aqueous nitric acid stream in the sump of 3^{rd} column. The sump of the final packed column is replenished with process water feed. Ozone is added in the final packed column to remove NOx as described in equations (6) to (10). The gas stream leaving the final packed column is directed to the stack with significantly reduced level of NOx with most in the form of recovered nitric acid. The number of packed columns in series can be preferably 2 to 6. They may be stacked on top of one another for sake of simple gravity overflow. Instead of packed column, any other gas liquid contacting device can also be used.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what I claim is:

1. A method for removing contaminants from a tail gas stream of a nitric acid production process wherein nitric acid is recovered from an absorber column comprising adding ozone to said absorber column.

2. The method as claimed in claim 1 wherein said contaminants are selected from the group consisting of nitrogen oxides.

3. The method as claimed in claim 1 wherein said absorber column is a multistage absorber column.

4. The method as claimed in claim 3 wherein said absorber column is a plate column having from 20 to 70 plates.

5. The method as claimed in claim 3 wherein said ozone contacts said nitrogen oxides in between said plates.

6. The method as claimed in claim 1 further comprising introducing oxygen into said absorber column.

7. The method as claimed in claim 1 wherein said ozone is introduced into a final stage of said absorber column.

8. The method as claimed in claim 1 wherein said ozone is raised to the pressure of said absorber column.

9. A method for removing contaminants from a tail gas stream of a nitric acid production process wherein nitric acid is recovered from an absorber column comprising feeding a process gas stream and an enhanced oxygen-containing stream into an absorber column and adding ozone to said absorber column.

10. The method as claimed in claim 9 wherein said contaminants are selected from the group consisting of nitrogen oxides.

11. The method as claimed in claim 9 wherein said absorber column is a multistage absorber column.

12. The method as claimed in claim 9 wherein said absorber column is a plate column having from 20 to 70 plates.

13. The method as claimed in claim 12 wherein said ozone contacts said nitrogen oxides in between said plates.

14. The method as claimed in claim 9 further comprising introducing oxygen into said absorber column.

15. The method as claimed in claim 14 wherein said ozone is introduced into a final stage of said absorber column.

16. The method as claimed in claim 9 wherein said ozone is raised to the pressure of said absorber column.

17. The method as claimed in claim 16 wherein said absorber column is a series of packed absorber columns.

18. The method as claimed in claim 17 wherein ozone is added to a final packed absorber column in said series of packed absorber columns.

19. A method for producing nitric acid comprising the steps of:
a) reacting ammonia in an ammonia converter;
b) feeding reaction products from step a) to a waste heat recovery unit;
c) feeding the reaction products from step b) to a heat exchanger thereby heating said reaction products;
d) feeding the reaction products of step c) to a cooler condenser thereby cooling said reaction products;
e) feeding the cooled reaction products of step d) to an absorber column wherein nitric acid is separated from a tail gas; and
f) feeding ozone to said absorber column to react with contaminants in said tail gas.

20. The method as claimed in claim 19 wherein said contaminants are selected from the group consisting of nitrogen oxides.

21. The method as claimed in claim 19 wherein said absorber column is a multistage absorber column.

22. The method as claimed in claim 21 wherein said absorber column is a plate column having from 20 to 70 plates.

23. The method as claimed in claim 21 wherein said ozone contacts said nitrogen oxides in between said plates.

24. The method as claimed in claim 19 further comprising introducing oxygen into said absorber column.

25. The method as claimed in claim 19 wherein said ozone is introduced into a final stage of said absorber column.

26. The method as claimed in claim 19 wherein said ozone is raised to the pressure of said absorber column.

27. A method for removing contaminants from a gas stream from an industrial process comprising the steps:
a) mixing said gas stream with a stoichiometric excess amount of oxygen;
b) feeding said gas stream mixture to a first packed column;
c) contacting said gas stream mixture with an aqueous nitric acid solution;
d) feeding the gas stream mixture of step c) to a second packed column and contacting with an aqueous nitric acid solution;
e) contacting said gas stream mixture in said second packed column with ozone; and
f) recovering said gas stream.

28. The method as claimed in claim 27 wherein said industrial process is selected from the group consisting of nitric acid oxidation of organic material and processing of substances with nitric acid.

29. The method as claimed in claim 27 wherein said contaminants are selected from the group consisting of nitrogen oxides.

30. The method as claimed in claim 27 wherein said nitric acid in said second packed column has a lower concentration than said nitric acid in said first packed column.

31. The method as claimed in claim 27 wherein two to six packed columns are used.

32. The method as claimed in claim 27 wherein a sump in said first packed column is replenished with aqueous nitric acid from said second packed column.

33. The method as claimed in claim 27 wherein a sump in said second packed column is replenished with process feed water.

34. The method as claimed in claim 27 wherein said packed column are in series.

35. The method as claimed in claim 34 wherein said packed columns are stacked vertically.
